(19) United States
(12) Patent Application Publication
(10) Pub. No.: US 2018/0137699 A1
(43) Pub. Date: May 17, 2018

(54) ROLLCALL SYSTEM AND ROLLCALL METHOD

(71) Applicant: Aengin Technology Inc., Taipei City (TW)

(72) Inventors: Kai-Chieh Yang, Taipei City (TW); Yi-Hsiang Chen, Taipei City (TW); Yi-Hsuang Chen, Taipei City (TW); Ning-Chain Hsu, Taipei City (TW)

(73) Assignee: Aengin Technology Inc., Taipei City (TW)

(21) Appl. No.: 15/810,139

(22) Filed: Nov. 13, 2017

Related U.S. Application Data
(60) Provisional application No. 62/423,161, filed on Nov. 16, 2016.

(30) Foreign Application Priority Data
Jun. 28, 2017 (TW) 106121660

(51) Int. Cl. G07C 9/00; G06K 7/10; G06K 17/00

(52) U.S. Cl. CPC G07C 9/00; H04L 67/42; G06K 17/0029; G06K 7/10425

(57) ABSTRACT

A rollcall system and a rollcall method are provided. The system includes a first signal transmitting device and a first electronic device. The first signal transmitting device transmits a first signal associated with a first user. The first electronic device detects the first signal and displays first prompt information based on the first signal. The first prompt information indicates first information of the first user in a first range adjacent to the first electronic device and second information of a second user not adjacent to the first range of the first electronic device.

### CROSS-REFERENCE TO RELATED APPLICATION

This application claims the priority benefits of U.S. provisional application Ser. No. 62/423,161, filed on Nov. 16, 2016, and Taiwan application serial no. 106121660, filed on Jun. 28, 2017. The entirety of each of the above-mentioned patent applications is hereby incorporated by reference herein and made a part of this specification.

### BACKGROUND OF THE INVENTION

### 1. Field of the Invention

The invention relates to a rollcall system.

### 2. Description of Related Art

When managing students, teachers often need to take a rollcall for the purpose of supervision. However, the conventional practice of taking a roll call is that teachers manually check which students are present and which students are absent. However, when there are a large number of students, the conventional practice of taking a rollcall may result in inefficient management.

### SUMMARY OF THE INVENTION

The invention provides a rollcall system and method. In the rollcall system and method, an electronic device may detect a signal of a signal transmitting device and learn a present student and an absent student based on the signal. Accordingly, attendance of the students is checked and the efficiency of personnel management is reinforced.

The invention provides a rollcall system including a first signal transmitting device and a first electronic device. The first signal transmitting device transmits a first signal associated with a first user. The first electronic device detects the first signal and displays first prompt information based on the first signal. The first prompt information indicates first information of the first user in a first range adjacent to the first electronic device and second information of a second user not adjacent to the first range of the first electronic device.

According to an embodiment of the invention, the first information is a first number of the first user or a first name of the first user, and the second information is a second number of the second user or a second name of the second user.

According to an embodiment of the invention, before an operation of displaying the first prompt information based on the first signal, the first electronic device sets group information including first identity information of the first user and second identity information of the second user.

According to an embodiment of the invention, the first identity information includes a first corresponding relation between a first identification code in the first signal and the first user, and the second identity information includes a second corresponding relation between a second identification code in a second signal and the second user.

According to an embodiment of the invention, in the operation of displaying the first prompt information based on the first signal, the first electronic device displays the first prompt information based on the first identification code in the first signal.

According to an embodiment of the invention, the system further includes a server and a second electronic device. The first electronic device transmits the first information of the first user and the second information of the second user to the server. The server transmits a notification message to the second electronic device based on the first information of the first user and the second information of the second user, and The second electronic device displays second prompt information based on the notification message. In addition, the second prompt information indicates the first information of the first user in the first range adjacent to the first electronic device and the second information of the second user not adjacent to the first range of the first electronic device.

According to an embodiment of the invention, the system further includes a third electronic device. Before the notification message is transmitted to the second electronic device based on the first information of the first user and the second information of the second user, the third electronic device sets an authorization of access of the second electronic device to allow the second electronic device to receive the notification message from the server.

According to an embodiment of the invention, the first signal associated with the first user is a beacon signal.

The invention provides a rollcall method adapted for a rollcall system including a first signal transmitting device and a first electronic device. The method includes: transmitting a first signal associated with a first user by the first signal transmitting device; and displaying second prompt information based on the notification message by the second electronic device, wherein the second prompt information indicates the first information of the first user in the first range adjacent to the first electronic device and the second information of the second user not adjacent to the first range of the first electronic device.

According to an embodiment of the invention, the first information is a first number of the first user or a first name of the first user, and the second information is a second number of the second user or a second name of the second user.

According to an embodiment of the invention, before displaying the first prompt information based on the first signal, the method further includes: setting group information including first identity information of the first user and second identity information of the second user by the first electronic device.

According to an embodiment of the invention, the first identity information includes a first corresponding relation between a first identification code in the first signal and the first user, and the second identity information includes a second corresponding relation between a second identification code in a second signal and the second user.

According to an embodiment of the invention, displaying the first prompt information based on the first signal includes: displaying the first prompt information based on the first identification code in the first signal by the first electronic device.

According to an embodiment of the invention, the rollcall system further includes a server and a second electronic device, and the method further includes: transmitting the first information of the first user and the second information of the second user to the server by the first electronic device; transmitting a notification message to the second electronic device based on the first information of the first user and the second information of the second user by the server, and displaying second prompt information based on the notification message by the second electronic device, wherein the second prompt information indicates the first information of the first user in the first range adjacent to the first electronic device and the second information of the second user not adjacent to the first range of the first electronic device.

According to an embodiment of the invention, the rollcall system further includes a third electronic device, and before transmitting the notification message to the second electronic device based on the first information of the first user and the second information of the second user, and the method further includes: setting an authorization of access of the second electronic device by the third electronic device to allow the second electronic device to receive the notification message from the server.

According to an embodiment of the invention, the first signal associated with the first user is a beacon signal.

Based on the above, in the rollcall system and method according to the embodiments of the invention, the electronic device may detect the signal of the signal transmitting device and learn the present student and the absent student based on the signal. Accordingly, attendance of the students is checked and the efficiency of personnel management is reinforced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a rollcall system according to an embodiment of the invention.

FIG. 2A is a schematic view illustrating an electronic device according to an embodiment of the invention.

FIG. 2B is a schematic view illustrating another electronic device according to an embodiment of the invention.

FIG. 2C is a schematic view illustrating a server according to an embodiment of the invention.

FIG. 2D is a schematic view illustrating a signal transmitting device according to an embodiment of the invention.

FIGS. 3A to 3E are schematic views illustrating frames of an application for a rollcall system according to an embodiment of the invention.

FIG. 4 is a schematic view illustrating displaying of an electronic device according to a notification message of a server according to an embodiment of the invention.

FIG. 5 is a flowchart illustrating a rollcall method according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Descriptions of the invention are given with reference to the exemplary embodiments illustrated with accompanied drawings, wherein same or similar parts are denoted with same reference numerals. In addition, whenever possible, identical or similar reference numbers stand for identical or similar elements in the figures and the embodiments.

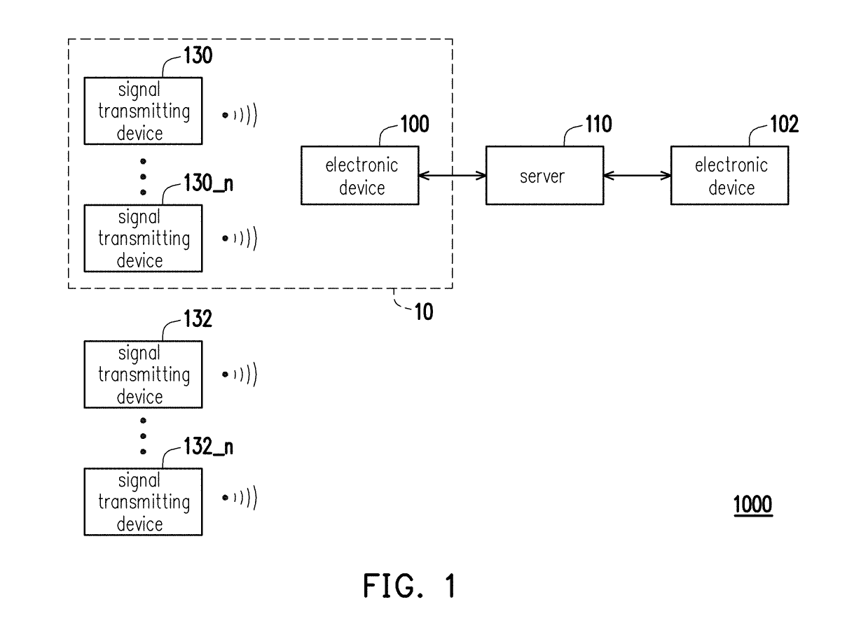

FIG. 1 is a schematic view illustrating a rollcall system according to an embodiment of the invention.

Referring to FIG. 1, a rollcall system 1000 includes an electronic device 100, an electronic device 102, a server 110, signal transmitting devices 130 to 130_n, and signal transmitting devices 132 to 132_n. The electronic device 100 and the electronic device 102 may respectively communicate with the server 110 via a wired or wireless network. In addition, in the exemplary embodiment, it is assumed that the signal transmitting devices 130 to 130_n (also referred to as first signal transmitting device) are located in a range 10 (also referred to as first range) adjacent to the electronic device 100, and the electronic device 100 is able to receive (or detect) signals respectively transmitted by the signal transmitting devices 130 to 130_n. In addition, it is assumed that the signal transmitting devices 132 to 132_n (also referred to as second signal transmitting device) are not located in the range 10 adjacent to the electronic device 100. Therefore, the electronic device 100 is unable to receive (or detect) signals transmitted by the signal transmitting devices 132 to 132_n. It should be noted that the invention does not intend to limit the numbers of the electronic device, the server, and the signal transmitting device in the rollcall system 1000.

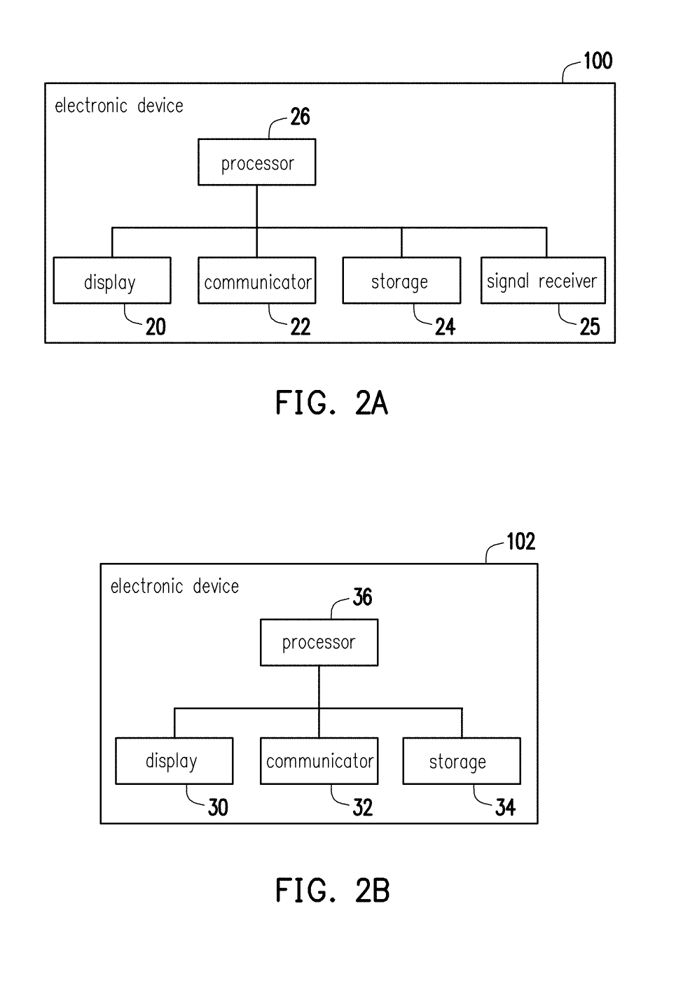

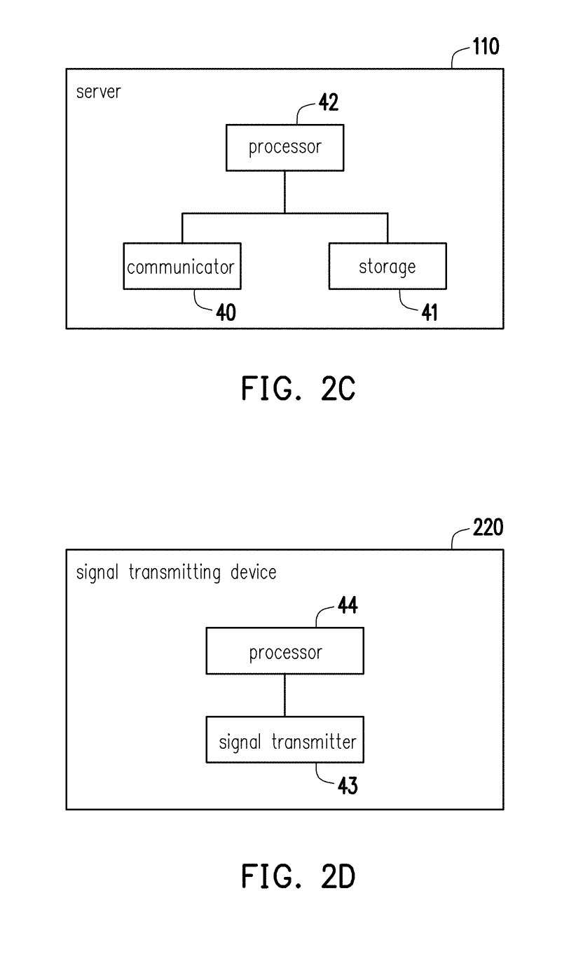

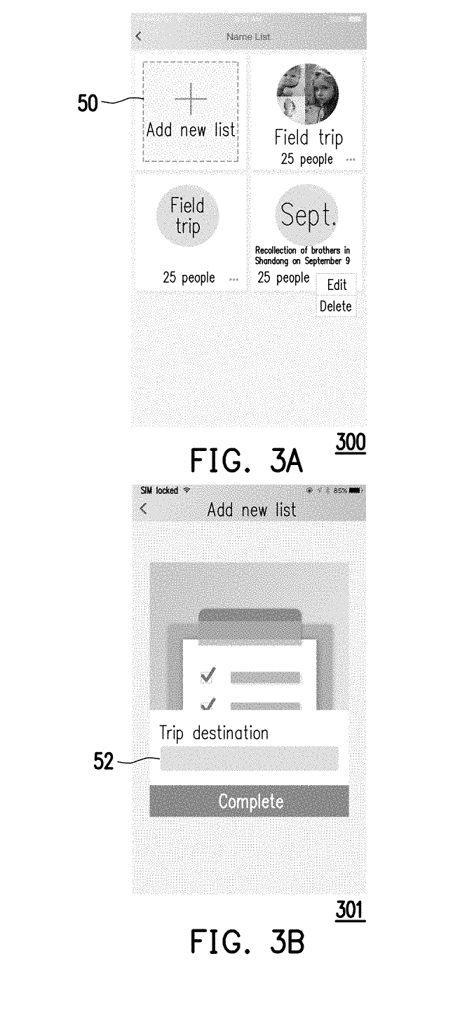

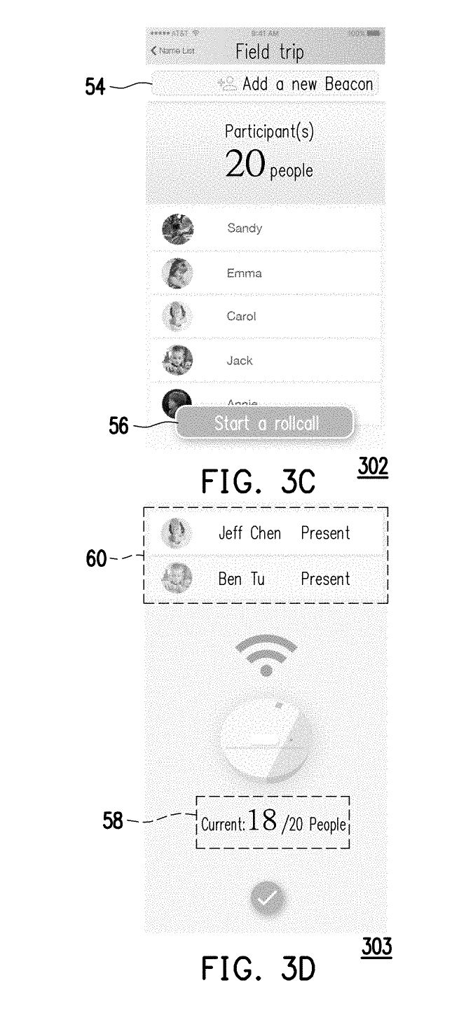

FIG. 2A is a schematic view illustrating an electronic device according to an embodiment of the invention.

Referring to FIG. 2A, the electronic device 100 includes a display 20, a communicator 22, a storage 24, a signal receiver 25, and a processor 26. In addition, the display 20, the communicator 22, the storage 24, and the signal receiver 25 are respectively coupled to the processor 26. The electronic device 200 is a mobile electronic device such as a mobile phone, a tablet computer, a notebook computer, or the like. However, it should be noted that the invention is not limited thereto.

The display 20 may be a display device providing a display function in a display area of the electronic device 200. The display 20 may be a display device capable of providing a display function, such as a liquid crystal display (LCD), a light emitting diode (LED) display, a field emission display (FED) or the like.

The communicator 22 may be an element adapted for signal transmission through the global system for mobile communication (GSM), the personal handy-phone system (PHS), the code division multiple access (CDMA) system, the wideband code division multiple access (WCDMA) system, the long term evolution (LTE) system, the worldwide interoperability for microwave access (WiMAX) system, the wireless fidelity (WiFi) system, or the Bluetooth system.

The storage 24 may be any type of static or mobile random access memory (RAM), read-only memory (ROM), flash memory, similar elements, or a combination thereof.

The signal receiver 25 may receive (or detect) the signals transmitted by the signal transmitters 130 to 130_n or the signals transmitted by the signal transmitting devices 132 to 132_n. In the exemplary embodiment, the signal receiver 50 is a signal receiver for receiving a beacon. However, the invention is not limited thereto. The signal receiver 25 may also be a signal receiver receiving (or sensing) other types of signals.

The processor 26 may be a central processing unit (CPU) or other programmable general-purpose or specific-purpose microprocessors, digital signal processors (DSP), programmable controllers, application specific integrated circuits (ASIC), other similar elements, or a combination thereof.

In the exemplary embodiment, a plurality of programming code segments are stored in the storage 24 of the electronic device 200. After the programming code segments are installed, the processor 26 may execute the programming code segments. For example, the storage 24 includes a plurality of modules. Respective operations of the electronic device 100 for the rollcall system 1000 are respectively carried out through the modules. In addition, the respective modules include one or more programming code segments. However, the invention is not limited thereto. The respective operations of the electronic device 100 may also be implemented in a hardware form.

FIG. 2B is a schematic view illustrating another electronic device according to an embodiment of the invention.

Referring to FIG. 2B, the electronic device 102 includes a display 30, a communicator 32, a storage 34, and a processor 36. In addition, the display 30, the communicator 32, and the storage 34 are respectively coupled to the processor 36. The display 30, the communicator 32, the storage 34, and the processor 36 may be elements respectively similar to the display 20, the communicator 22, the storage 24, and the processor 26. Thus, details in this regard will not be repeated in the following.

In the exemplary embodiment, a plurality of programming code segments are stored in the storage 34 of the electronic device 102. After the programming code segments are installed, the processor 36 may execute the programming code segments. For example, the storage 34 includes a plurality of modules. Respective operations of the electronic device 102 for the rollcall system 1000 are respectively carried out through the modules. In addition, the respective modules include one or more programming code segments. However, the invention is not limited thereto. The respective operations of the electronic device 102 may also be implemented in a hardware form.

FIG. 2C is a schematic view illustrating a server according to an embodiment of the invention.

Referring to FIG. 2C, the server 110 includes a communicator 40, a storage 41, and a processor 42. In addition, the communicator 40 and the storage 41 are respectively coupled to the processor 42. The communicator 40, the storage 41, and the processor 42 may be elements respectively similar to the communicator 22, the storage 24, and the processor 26. Thus, details in this regard will not be repeated in the following.

In the exemplary embodiment, a plurality of programming code segments are stored in the storage 41 of the server 110. After the programming code segments are installed, the processor 42 may execute the programming code segments. For example, the storage 41 includes a plurality of modules. Respective operations of the server 110 for the rollcall system 1000 are respectively carried out through the modules. In addition, the respective modules include one or more programming code segments. However, the invention is not limited thereto. The respective operations of the server 110 may also be implemented in a hardware form.

FIG. 2D is a schematic view illustrating a signal transmitting device according to an embodiment of the invention. It should be noted that, since the signal transmitting devices 130 to 130_n, the signal transmitting devices 132 to 132_n in FIG. 1 may substantially have similar elements, the elements required by the electronic devices are only described using a signal transmitting device 220 as an example.

Referring to FIG. 2D, the signal transmitting device 220 includes a signal transmitter 43 and a processor 44. In addition, the signal transmitter 43 is coupled to the processor 44. The processor 44 may be an element similar to the processor 26. Thus, details in this regard will not be repeated in the following.

The signal transmitter 43 may be a transmitter for transmitting a signal. The signal transmitted by the transmitter may include an identification code. The identification code may server to identify an identity of the user possessing the signal transmitting device 220, for example. In the exemplary embodiment, the signal transmitter 43 is a transmitter for transmitting a beacon. However, the invention is not limited thereto. The signal transmitter 43 may also be a signal transmitter transmitting other types of signals.

Referring to FIG. 1 again, in the rollcall system 1000 of the invention, the signal transmitting devices 130 to 130_n and the signal transmitting devices 132 to 132_n are wore by monitored users (e.g., students), for example. It is assumed that each student wears one of the signal transmitting devices. Other users (e.g., teachers or school staff members) may learn relevant information of the students wearing the signal transmitting devices 130 to 130_n in the range 10 detectable by the electronic device 100 and relevant information of the students wearing the signal transmitting devices 132 to 132_n not in the range 10 through the electronic device 100 or the electronic device 102. In the following, an example of a teacher taking a rollcall is described in the following.

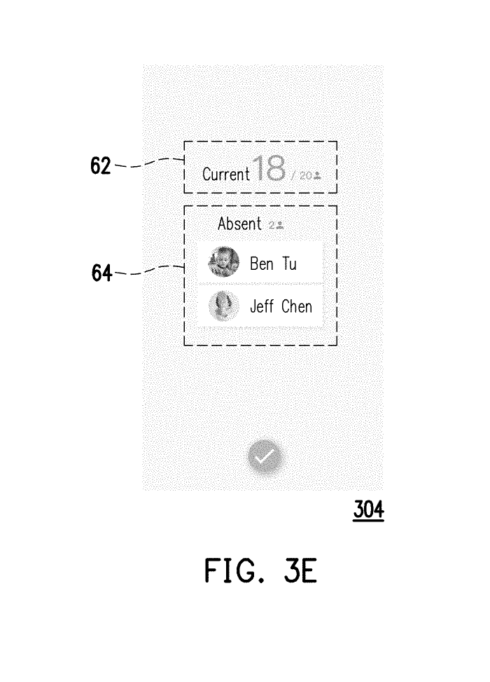

For example, FIGS. 3A to 3E are schematic views illustrating frames of an application for a rollcall system according to an embodiment of the invention. Referring to FIGS. 1 and 3A, first of all, an application for the rollcall system 1000 according to an embodiment of the invention may be installed to the electronic device 100, for example. It is assumed that the electronic device 100 is possessed by a teacher. The teacher may configure group information of one or more students to be monitored through the electronic device 100. For example, the teacher may click on a field 50 in a frame 300 displayed by the electronic device 100 to set up (or add) a group.

Then, referring to FIG. 3B, after clicking on the field 50 in FIG. 3A, the electronic device may display a frame 301. The teacher may name the group by inputting a name to a field 52 of the frame 301.

Then, referring to FIG. 3C, after the group is named, the electronic device 100 may display a frame 302. The teacher may add identity information of the student to be monitored through a field 54 of the frame 302.

For example, the teacher may add identity information of each of the students wearing the signal transmitting devices 130 to 130_n and the signal transmitting devices 132 to 132_n through the field 54 of the frame 302. The identity information includes a corresponding relation between an identification code in the beacon transmitted by the signal transmitting device wore by the student and the student. For example, the teacher may set the corresponding relation between the identification code in the beacon transmitted by the signal transmitting device 130 and the student wearing the signal transmitting device 130, and may also set the corresponding relation between the identification code in the beacon transmitted by the signal transmitting device 132 and the student wearing the signal transmitting device 132. The rest of the students and the signal transmitting devices follow the same principle. Particularly, the corresponding relation may be a corresponding relation between the identification code of the beacon and the name of the student, for example. However, the invention is not limited thereto. Besides, in addition to setting the students' names, the teacher may also set photos of the students wearing the signal transmitting devices through the application of the electronic device 100.

After setting of the group information is completed, the teacher may take a rollcall through the electronic device 100. For example, the teacher may click on an option 56 in the frame 302, so that the electronic device 100 may start detecting the signals transmitted by the signal transmitting devices 130 to 130_n and the signal transmitting devices 132 to 132_n. In the exemplary embodiment of FIG. 1, since only the signal transmitting devices 130 to 130_n are located in the range 10 detectable by the electronic device 100, the electronic device 100 may receive (or detect) the signals (also referred to as first signal) transmitted by the signal transmitting devices 130 to 130_n.

Then, referring to FIGS. 3D to 3E, as shown in frames 303 and 304, the electronic device 100 may display prompt information (also referred to as first prompt information) based on identification codes (also referred to as first identification code) in the first signals. The first prompt information indicates information (also referred to as first information) of the students wearing the signal transmitting devices 130 to 130_n in the range 10 adjacent to the electronic device 100 and information (also referred to as second information) of the students (also referred to as second user) not adjacent to the range 10 of the electronic device 100. In addition, the first information may be the number (also referred to as first number) of the students (also referred to as first user) wearing the signal transmitting devices 130 to 130_n or names (also referred to as first name) of the students wearing the signal transmitting devices 130 to 130_n. The second information may be the number (also referred to as second number) of the students (also referred to as second user) wearing the signal transmitting devices 132 to 132_n or names (also referred to as second name) of the students wearing the signal transmitting devices 132 to 132_n.

In other words, the first number may represent the number of students present when the teacher takes the rollcall, and the first names represent the names of the present students, whereas the second number may represent the number of students absent when the teacher takes the rollcall, and the second names represent the names of the absent students. For example, a field 58 of the frame 303 displays the number of currently present students and an expected total number of students, whereas a field 60 of the frame 303 displays the names of the present students. As another example, a field 62 of the frame 304 displays the number of currently present students and the expected total number of students, whereas a field 64 of the frame 304 displays the names and number of absent students.

It should be noted that the rollcall system is applicable when the teacher takes a rollcall in the classroom or in an outdoor environment. The invention does not intend to impose a limitation on this regard. Moreover, after taking a rollcall, the teacher may switch the application to the background. When there is a change in the number of people present, the application may immediately transmit a push message to notify the teacher.

Besides, as shown in the frame 300 of FIG. 3A, the teacher may also add a plurality of different groups through the application of the electronic device 100. The teacher may take rollcalls of students in different groups by choosing corresponding groups, thereby making it more convenient to take the rollcall.

It should be noted that, when there is no infrastructure of the Internet, it is still possible to carry out the detection by receiving the signal transmitted by the signal transmitting device 130 through the electronic device 100. Moreover, when the electronic device 100 is connected to a network, the electronic device 100 may also upload the first information of the present students or the second information of the absent students to the server 110. The server 110 may transmit the first information and the second information to the electronic device 102. Therefore, the user (e.g., a school staff member) of the electronic device 102 is informed of attendance information of the students.

For example, when the school staff member intends to learn the student's location through the electronic device 102, authorization must be set in advance through another electronic device. For example, the teacher may set the authorization of the school staff member through an application of the electronic device 100 or another electronic device (also referred to as third electronic device). Taking the teacher setting the authorization of the school staff member through the electronic device 100 as an example, the teacher may input a user record through the application of the electronic device 100. The user record includes account information of the school staff member, and the account information may be an e-mail address, for example. The electronic device 102 of the school staff member is able to receive a notification message from the server 110 only after the setting is completed.

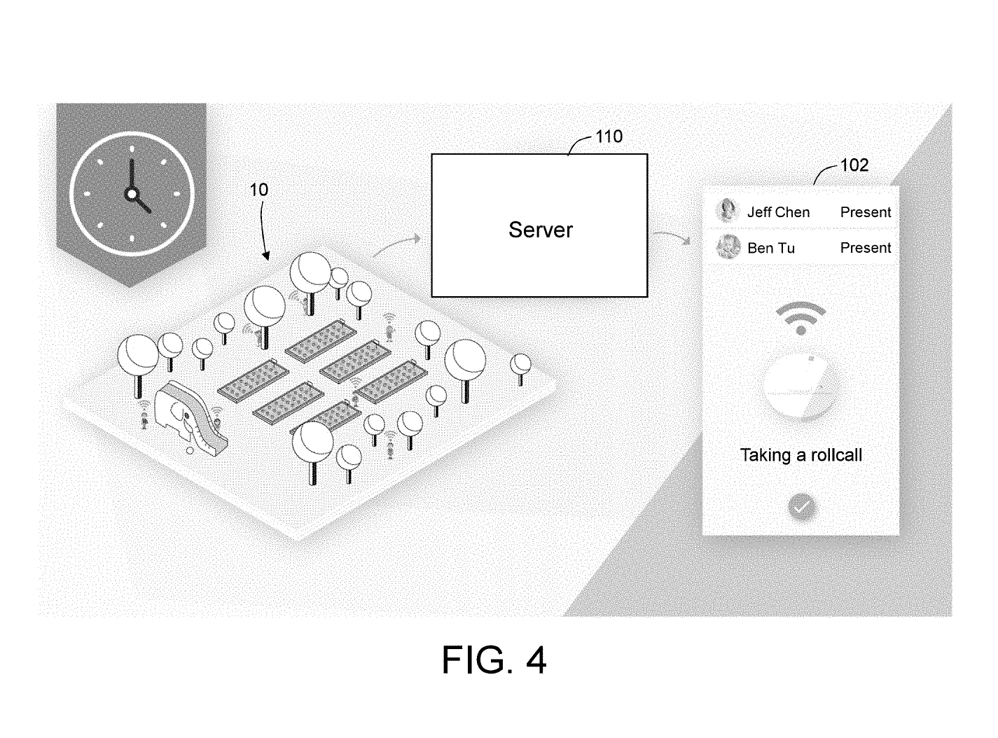

More specifically, FIG. 4 is a schematic view illustrating displaying of an electronic device according to a notification message of a server according to an embodiment of the invention. Referring to FIG. 4, following the exemplary embodiment of FIG. 1, the school staff member may log on with his/her e-mail address. When the electronic device 100 obtains the first information of the present students and the second information of the absent students by detecting the signals of the signal transmitting devices 130 to 130_n, the electronic device 100 may transmit the first information and the second information to the server 110 when the electronic device 100 is connected to the Internet. Then, the server 110 may transmit a notification message to the electronic device 102 based on the first information and the second information. The electronic device 102 may display prompt information (also referred to as second prompt information) based on the notification message. The second prompt information indicates the first information of the students in the range 10 adjacent to the electronic device 100 and the second information of the students not adjacent to the range 10 of the electronic device 100. Similarly, the first information may be the number of students wearing the signal transmitting devices 130 to 130_n or the names of the students wearing the signal transmitting devices 130 to 130_n. The second information may be the number of students wearing the signal transmitting devices 132 to 132_n or the names of the students wearing the signal transmitting devices 132 to 132_n.

In other words, through the setting of authorization, the school staff member with the authorization of access may receive the notification message from the server. Besides, the case that an unauthorized user learns the presence/absence of the students wearing the signal transmitting devices is avoided, and security of the system is thus reinforced.

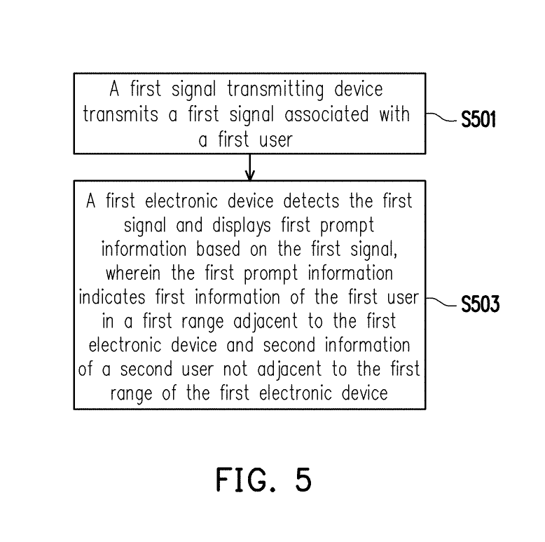

FIG. 5 is a flowchart illustrating a rollcall method according to an embodiment of the invention.

Referring to FIG. 5, at Step S501, a first signal transmitting device transmits a first signal associated with a first user. At Step S503, a first electronic device detects the first signal and displays first prompt information based on the first signal. The first prompt information indicates first information of the first user in a first range adjacent to the first electronic device and second information of a second user not adjacent to the first range of the first electronic device.

In view of the foregoing, in the rollcall system according to the embodiments of the invention, the electronic device may detect the signal of the signal transmitting device and learn the present student and the absent student based on the signal. Accordingly, the attendance of the students is checked and the efficiency of personnel management is reinforced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A rollcall system, comprising:
a first signal transmitting device, transmitting a first signal associated with a first user; and
a first electronic device, detecting the first signal and displaying first prompt information based on the first signal,
wherein the first prompt information indicates first information of the first user in a first range adjacent to the first electronic device and second information of a second user not adjacent to the first range of the first electronic device.

2. The rollcall system as claimed in claim 1, wherein:
wherein the first information is a first number of the first user or a first name of the first user, and the second information is a second number of the second user or a second name of the second user.

3. The rollcall system as claimed in claim 1, wherein before an operation of displaying the first prompt information based on the first signal,
the first electronic device sets group information comprising first identity information of the first user and second identity information of the second user.

4. The rollcall system as claimed in claim 3, wherein:
the first identity information comprises a first corresponding relation between a first identification code in the first signal and the first user, and the second identity information comprises a second corresponding relation between a second identification code in a second signal and the second user.

5. The rollcall system as claimed in claim 4, in the operation of displaying the first prompt information based on the first signal,
the first electronic device displays the first prompt information based on the first identification code in the first signal.

6. The rollcall system as claimed in claim 1, further comprising:
a server; and
a second electronic device, wherein:
the first electronic device transmits the first information of the first user and the second information of the second user to the server,
the server transmits a notification message to the second electronic device based on the first information of the first user and the second information of the second user, and
the second electronic device displays second prompt information based on the notification message, wherein the second prompt information indicates the first information of the first user in the first range adjacent to the first electronic device and the second information of the second user not adjacent to the first range of the first electronic device.

7. The rollcall system as claimed in claim 6, further comprising:
a third electronic device, wherein before the notification message is transmitted to the second electronic device based on the first information of the first user and the second information of the second user,
the third electronic device sets an authorization of access of the second electronic device to allow the second electronic device to receive the notification message from the server.

8. The rollcall system as claimed in claim 1, wherein the first signal associated with the first user is a beacon signal.

9. A rollcall method, adapted for a rollcall system comprising a first signal transmitting device and a first electronic device, the method comprising:
transmitting a first signal associated with a first user by the first signal transmitting device; and
detecting the first signal and displaying first prompt information based on the first signal by the first electronic device,
wherein the first prompt information indicates first information of the first user in a first range adjacent to the first electronic device and second information of a second user not adjacent to the first range of the first electronic device.

10. The rollcall method as claimed in claim 9, wherein the first information is a first number of the first user or a first name of the first user, and the second information is a second number of the second user or a second name of the second user.

11. The rollcall method as claimed in claim 9, wherein before displaying the first prompt information based on the first signal, the method further comprises:
setting group information comprising first identity information of the first user and second identity information of the second user by the first electronic device.

12. The rollcall method as claimed in claim 11, wherein the first identity information comprises a first corresponding relation between a first identification code in the first signal and the first user, and the second identity information comprises a second corresponding relation between a second identification code in a second signal and the second user.

13. The rollcall method as claimed in claim 12, wherein displaying the first prompt information based on the first signal comprises:
displaying the first prompt information based on the first identification code in the first signal by the first electronic device.

14. The rollcall method as claimed in claim 9, wherein the rollcall system further comprises a server and a second electronic device, and the method further comprises:
transmitting the first information of the first user and the second information of the second user to the server by the first electronic device;
transmitting a notification message to the second electronic device based on the first information of the first user and the second information of the second user by the server; and
displaying second prompt information based on the notification message by the second electronic device, wherein the second prompt information indicates the first information of the first user in the first range adjacent to the first electronic device and the second information of the second user not adjacent to the first range of the first electronic device.

15. The rollcall method as claimed in claim 14, wherein the rollcall system further comprises a third electronic device, and before transmitting the notification message to the second electronic device based on the first information of the first user and the second information of the second user, and the method further comprises:
setting an authorization of access of the second electronic device by the third electronic device to allow the second electronic device to receive the notification message from the server.

16. The rollcall method as claimed in claim 9, wherein the first signal associated with the first user is a beacon signal.
